(19) United States
(12) Patent Application Publication
(10) Pub. No.: US 2004/0044623 A1
(43) Pub. Date: Mar. 4, 2004

(54) Billing system for wireless device activity

(76) Inventors: Susan L. Wake, Escondido, CA (US); Julie Yu, San Diego, CA (US)

Correspondence Address: Qualcomm Incorporated, Patents Department, 5775 Morehouse Drive, San Diego, CA, 92121-1714, US

(21) Appl. No.: 10/231,818

(22) Filed: Aug. 28, 2002

(51) Int. Cl. G06F 17/60

(52) U.S. Cl. 705/40

(57) ABSTRACT

A system, method, and computer program for tracking billable events occurring on wireless devices on a wireless network and billing the appropriate parties. The billable events occur from the end-users of the wireless devices selectively communicating with other computer devices across the wireless network and downloading and executing software applications thereupon. The billable event data is ultimately gathered at a server on the wireless network from which billing for the wireless device billable events can be generated.

### BACKGROUND OF THE INVENTION

I. Field of the Invention

The present invention generally relates to wireless devices and wireless networks. More particularly, the invention relates to a system and method for tracking billable events occurring on wireless devices from their activation, downloading, and execution of software applications, and generating an appropriate bill for the billable events.

II. Description of the Related Art

Wireless devices, such as cellular telephones, communicate packets including voice and data over a wireless network. In existing wireless telecommunication systems, such as cellular telecommunication systems, fees are charged to the subscriber for the initial activation of a telecommunication device and then fees can be charged for ongoing airtime and device usage. However, existing systems typically do not account for other activities at the telecommunication device beyond airtime usage.

Further, if the subscriber of the wireless device desires to download and use a software application or upgrade the functionality of the telecommunication device, the user will typically either call a service provider or contact the service provider through another electronic means, such as through a separate Internet access. In some instances, the service provider can transmit the application to the wireless device across the wireless network (through a one time direct access download) or allow the user access a network site with the wireless device through the wireless network and at such site the application is downloadable or accessible to the subscriber. Otherwise service personnel of the provider must have physical access to the telecommunication device to install the software or upgrade the components thereof.

The existing systems for monitoring and billing for wireless telecommunication device activity thus do not allow a service provider to monitor non-airtime activities on the wireless device. In order to provide any additional billed services to the subscriber or end-user of the telecommunication device, the service provider must have the subscriber contact the service provider which involves additional allocation of provider resources and inconvenience to the subscriber. Accordingly, it is to a system and method that allows the monitoring and billing of wireless device activity that the present invention is primarily directed.

### SUMMARY OF THE INVENTION

The invention is a system, method, and computer program for tracking billable events occurring on wireless devices on a wireless network and billing the appropriate parties. The billable events occur from the activity of the end-users of the wireless devices through selectively communicating with other computer devices across the wireless network, such as application download servers, and downloading and executing software applications at the wireless device. The billable event data is ultimately gathered at a computer device, such as a billing server, on the wireless network and the computer device can generate the appropriate billing for the billable events of each wireless device. Billable events can be application downloads, executions, menu access, data transfer, diagnostics, and any value-added data interaction between the wireless device and a server or other computer device.

One embodiment of the system for tracking billable events utilizes at least one server that is selectively in communication with the one or more wireless devices across the wireless network where each wireless device has an end-user thereof and computer platform to which applications can be downloaded and executed software applications thereupon and accessible by the end-user. The end-user interaction with the wireless device and with other computer devices across the wireless network causes one or more billable event, and the billable event data for the one or more wireless devices is gathered at the at least one server.

The method for tracking billable events occurring on the wireless devices includes the steps of causing one or more billable events to occur through end-user interaction with the wireless device and such activities as accessing, downloading, and executing software applications from other computer devices on the wireless network. The method also includes the steps of creating billable event data based upon the one or more billable events, either at the wireless device, the server or other computer device, or both, and gathering the billable event data preferably at least at the one billing server.

The system and method accordingly allow service providers the ability to monitor and bill for wireless telecommunication device activity such as application download and execution, and other non-airtime activities on the wireless device. The system and method accordingly give an advantage to the service provider in that the provider can give additional services to the subscribers and end-user of the wireless device and effectively capture the revenue from the billed services. Moreover, the billing system does not require the subscriber to contact the service provider to initially receive the additional service.

Other objects, advantages, and features of the present invention will become apparent after review of the hereinafter set forth Brief Description of the Drawings, Detailed Description of the Invention, and the claims.

### BRIEF DESCRIPTION OF THE DRAWINGS

FIG. 1 is a representative diagram of a wireless network and the computer hardware and wireless devices that can be used within the wireless device billing system.

FIG. 2 is a block diagram illustrating a cellular telecommunication network with the billing system tracking billable events occurring on wireless telephones that interact with servers and other computer devices across the wireless network.

FIG. 3 is an application download menu that is presented to end-users of the wireless device when contacting an application download server across the wireless network, and a plurality of downloadable applications is represented on the display.

FIG. 4 is a flowchart illustrating one embodiment of the process executing on the computer platform of the wireless device wherein billable event data is transmitted from the wireless device as the events are completed.

FIG. 5 is a flowchart illustrating another embodiment of the process executing on the computer platform of the wireless device wherein billable event data is gathered at the wireless device and then either periodically transmitted from the wireless device to the billing server, or transmitted in response to a request from the billing server for transmission of billable event data.

FIG. 6 is a flowchart illustrating one embodiment of the process executing on the billing server that receives a request to generate billing for the billable events of the wireless devices, and then gathers and processes the billable event data for each of the wireless devices to create billing information that can be transmitted to the carrier or other billing entity for the wireless devices.

### DETAILED DESCRIPTION OF THE INVENTION

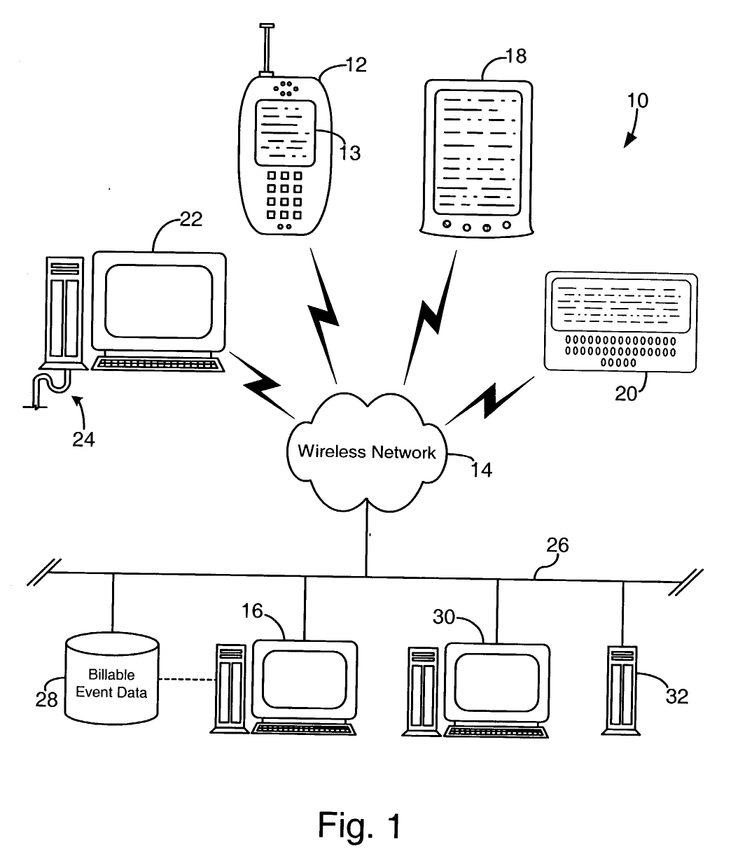

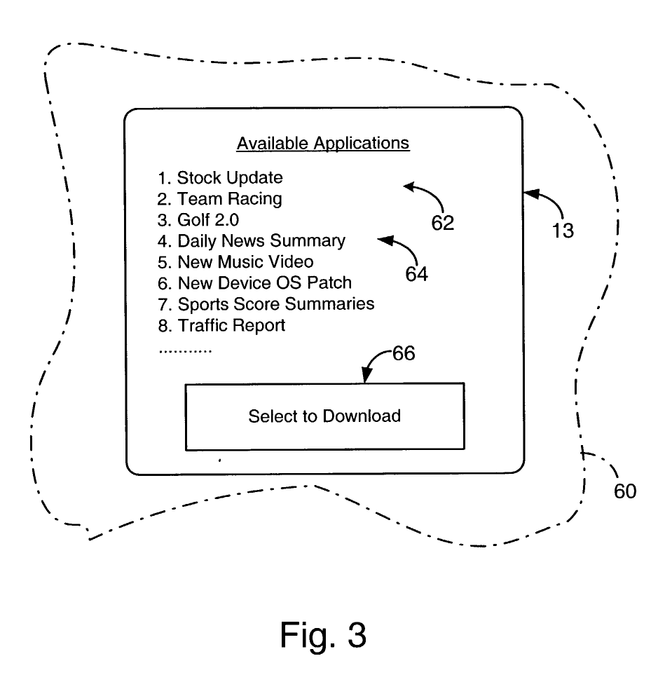

With reference to the figures in which like numerals represent like elements throughout, FIG. 1 illustrates one embodiment of the present inventive system 10 for tracking billable events occurring on one or more wireless devices, such as cellular telephone 12, in communication across a wireless network 14 with at least one application download server 16 that selectively downloads software applications or other data to the wireless devices across a wireless communication portal or other data access to the wireless network 14. In developing wireless networks 14, if the end-user of the wireless device desires to download and use a software application, the end-user will attempt to connect to the application download server 30 through bridging a communication connection to the wireless network 14, and attempt to download the desired software application. Once the wireless device contacts the application download server 30, an initial contact is made and the application download server 16 can determine what applications and data are available to that wireless device 12,18,20,22 and send the appropriate information, such as a menu (FIG. 3), for display on the wireless device 12,18,20,22 so the end-user can learn of the available applications. As shown here, the wireless device can be a cellular telephone 12, with a graphics display 13, a personal digital assistant 18, a pager 20 with a graphics display, which is shown here as a two-way text pager, or even a separate computer platform 22 that has a wireless communication portal, and may otherwise have a wired connection 24 to a network or the Internet. The system 10 can thus be performed on any form of remote computer module including a wireless communication portal, including without limitation, wireless modems, PCMCIA cards, access terminals, personal computers, access terminals, telephones without a display or keypad, or any combination or sub-combination thereof. Further, the term “application” as used herein is intended to encompass executable and nonexecutable software files, raw data, aggregated data, patches, and other code segments.

In the system 10, one or more wireless devices 12,18,20,22 are in selective communication with the wireless network 14, each has and end-user thereof that typically controls the communication connection to the wireless network 14. Each wireless device has an end-user thereof who can selectively access, download and execute software applications or otherwise interact with servers accessible via the wireless network 14. The system 10 accordingly allows the tracking of billable events based upon end-user interaction at the wireless device and with other computer devices through the wireless device 12,18,20,22 and across the wireless network 14.

The one or more wireless devices 12,18,20,22 selectively communicate with other computer devices across a wireless network, such as a billing server 16 or application download server 30 shown here on a local server-side network 26, or other computer elements in communication with the wireless network 14, such as a billable event database 28 that contains the billable event data for the wireless devices. The application download server 30 and a standalone server 32 are provided value-added services to the wireless devices, such as downloadable applications and other interaction, such as live stock quotes, news, and interactive games. All of the components can work in tandem to gather data relative to billable events of the wireless devices 12,18,20,22 and aggregate the billable event data at the billing server 16 as is further described herein. However, it should be noted that all server-side functions can be performed on one server, such as application download server 16. Further, any computer or server-side computer platform can provide separate services and processes to the wireless devices 12,18,20,22 across the wireless network 14.

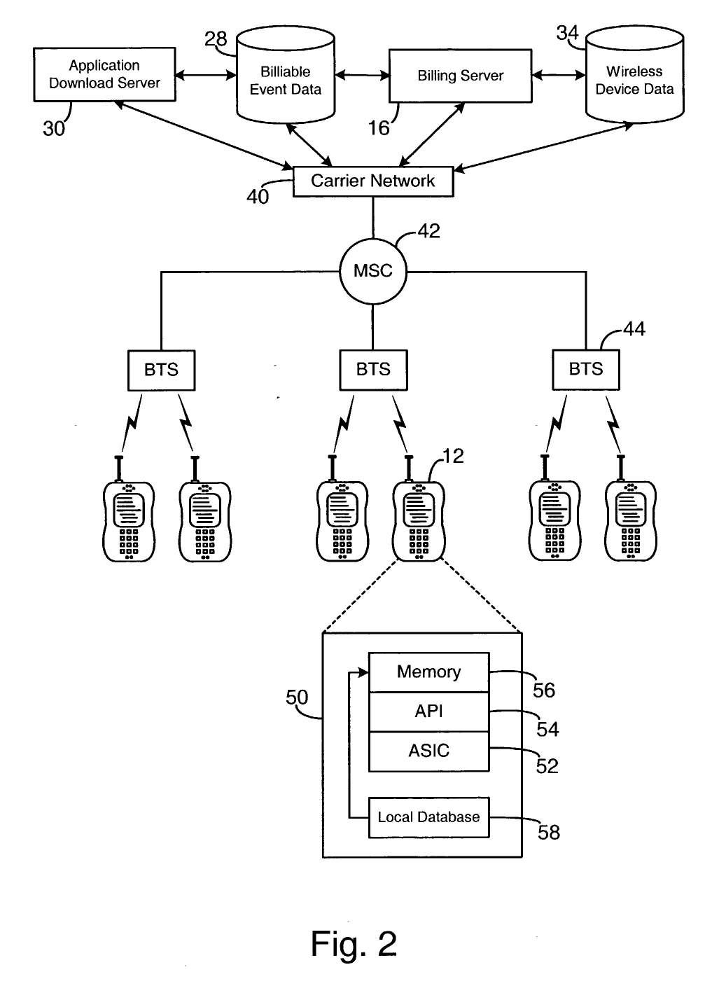

FIG. 2 is a block diagram that more fully illustrates the components of the wireless network 14 and interrelation of the elements of the system 10. The wireless network 14 is merely exemplary and can include any system whereby remote modules, such as wireless devices 12,18,20,22, communicate over-the-air between and among each other and/or between and among components of a wireless network 14, including, without limitation, wireless network carriers and/or servers. The server side components are a billing server 16, application download server 30, a billable event database 28 and a wireless device database 34. Other server-side components will be present on the cellular data network with any other components that are needed to provide cellular telecommunication services. The server-side components as embodied in FIG. 2 can by themselves create a billing system 10 solely through tracking applications downloaded from the application download server 30 and the billing is generated through correlation of the billable event database 28 and wireless device database 34 by the billing server 16.

The server-side components communicate with a carrier network 40 through a data link, such as the Internet, a secure LAN, WAN, or other network. The carrier network 40 controls messages (generally in the form of data packets) sent to a messaging service controller (“MSC”) 42. The carrier network 40 communicates with the MSC 42 by a network, the Internet and/or POTS (“plain ordinary telephone system”). Typically, the network or Internet connection between the carrier network 40 and the MSC 42 transfers data, and the POTS transfers voice information. The MSC 42 is connected to multiple base stations (“BTS”) 44. In a similar manner to the carrier network, the MSC 42 is typically connected to the BTS 44 by both the network and/or Internet for data transfer and POTS for voice information. The BTS 44 ultimately broadcasts messages wirelessly to the wireless devices, such as cellular telephone 12, by short messaging service (“SMS”), or other over-the-air methods known in the art.

The wireless device, such as cellular telephone 12, has a computer platform 50 that can receive and execute software applications transmitted from the application download server 16. The computer platform 50 includes, among other components, an application-specific integrated circuit (“ASIC”) 52, or other processor, microprocessor, logic circuit, programmable gate array, or other data processing device. The ASIC 52 is installed at the time of manufacture of the wireless device and is not normally upgradeable. The ASIC 52 or other processor executes an application programming interface (“API”) layer 54 that interfaces with any resident programs in the memory 56 of the wireless device. The memory can be comprised of read-only or random-access memory (RAM and ROM), EPROM, EEPROM, flash cards, or any memory common to computer platforms. The computer platform 50 also includes a local database 58 that can hold the software applications not actively used in memory 56, such as the software applications downloaded from the application download server 16. The local database 58 is typically comprised of one or more flash memory cells, but can be any secondary or tertiary storage device as known in the art, such as magnetic media, EPROM, EEPROM, optical media, tape, or soft or hard disk.

Cellular telephones and telecommunication devices, such as cellular telephone 12, are being manufactured with increased computing capabilities and are becoming tantamount to personal computers and hand-held personal digital assistants (“PDAs”). These “smart” cellular telephones allow software developers to create software applications that are downloadable and executable on the processor, such as ASIC 52, of the cellular device. The wireless device, such as cellular telephone 12, can download many types of applications, such as games and stock monitors, or simply data such as news and sports-related data. The downloaded data or executed applications can be immediately displayed on the display 13 or stored in the local database 58 when not in use. The software applications can be treated as a regular software application resident on the wireless device 12,18,20,22, and the user can selectively upload stored resident applications from the local database 58 to memory 56 for execution on the API 54. The user of the wireless device 12,18,20,22 can also selectively delete a software application from the local database 58. As a result, end-users of cellular telephones 12 can customize their telephones with programs, such as games, printed media, stock updates, news, or any other type of information or program available for download from application download servers through the wireless network 14.

The use of these value added services by the wireless device 12,18,20,22 causes billable events for which the service provider will bill the subscriber of the wireless device, who is not necessarily the end-user of the wireless device at the time of the billable event. The billable events typically occur from the end-user conducting some activity with applications provided from the application download server 30. Examples of billable events, include but are not to be limited to, downloading an application from an application download server 30 on the wireless network 14 to the wireless device computer platform 50; the execution of an application on the wireless device 12,18,20,22; accessing an application resident on another computer device on the wireless network 14, such as application download server 30, stand-alone server 32, or a database; and the elapse of a duration of execution of an application on the computer platform 50 of the wireless device, or other parameter of execution or interaction therewith. Any appropriate fee schedule can be used for the billable events, such as one-time fees, periodic fees, increasing or decreasing scales based upon time or number of uses.

As a further example, FIG. 3 is a partial view 60 of the display 13 having an downloadable applications menu 62 shown thereon listing a plurality of applications 64 downloadable to wireless devices 12,18,20,22, as instructed at download button 66. The applications menu 62 is displayed to the end-user of the wireless device when contacting the application download server 30, and the subscriber for the wireless device (end-user or not) will be billed for one or more of the downloaded applications. Alternately, if so embodied, the end-user can download the application to the wireless device 12,18,20,22 for a trial period, and after the elapse of the trial period, such as a straight number of days or predetermined period of application execution, the billable event will occur to charge the subscriber.

The billable event data for the one or more wireless devices 12,18,20,22 is ultimately gathered at billing server 16 such that the billing information for each wireless device. As embodied in FIG. 2, the billing information will ultimately be provided to the carrier network 40 for billing to the carrier's subscriber. However, the billing server 16 itself can generate a bill to the wireless device subscriber, for whom it can access the information of the wireless device data 34. While the billable event data is ultimately gathered at the billing server 16, the wireless device 12,18,20,22 can also gather the billable event data and transmit it periodically to the billing server 16. The wireless devices can transmit billable event data to the billing server 16 at the completion of the billable event, upon query from the billing server 16 server, or at a predetermined interval of time, e.g. every 30 minutes while active. And if the billing server 16 further generates a bill for a wireless device 12,18,20,22 based upon the gathered billable event data, the generated bill can transmitted from the billing server 16 to another computer device on the wireless network 14, such as a stand alone server 32 or the carrier network 40 for use by the carrier in billing its subscribers.

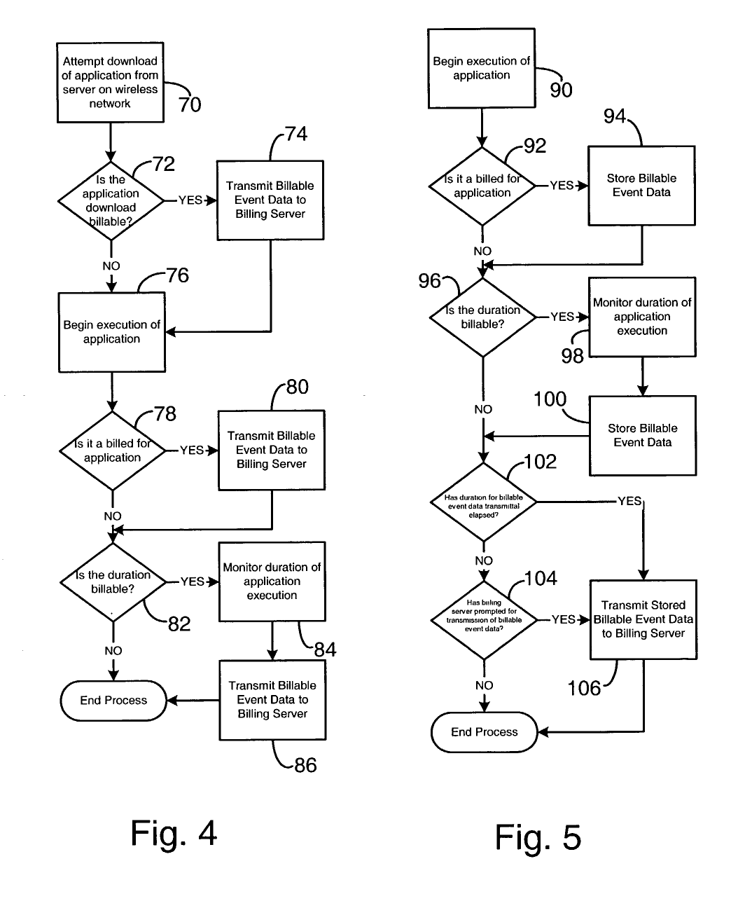

FIG. 4 is a flowchart illustrating one embodiment of the process executing on the computer platform 50 of the wireless device 12,18,20,22 wherein billable event data is transmitted from the wireless device as the billable events are completed. The process begins with the wireless device 12,18,20,22 attempting to download an application from an application download server 30 on the wireless network 14, as shown at step 70, and then a determination is made as to whether the application download is a billable event, as shown at decision 72. The data necessary to determine whether the download is a billable event can be stored locally at the wireless device 12,18,20,22 or a flag or other indication can come from the application download server 30 to notify the wireless device of a billable download, or such indication can come from another computer device monitoring the download and notifying the wireless device 12,18,20,22. If a billable event is indicated at decision 72, then the billable event data is transmitted to the billing server 16, as shown at step 74. Then, and also if the application download is not indicated as a billable event at decision 72, the application is executed (at some point after download) as shown at step 76. At the execution of the application, a determination is made as to whether the execution of the application is billed for, as shown at decision 78. If a billable event is indicated at decision 78, then the billable event data is transmitted to the billing server 16, as shown at step 80. Then, and also if the application execution is not indicated as a billable event at decision 78, a determination is made as to whether the duration of execution of the application (or some other periodic event) is billable, as shown at decision 82.

If a billable event is indicated at decision 82, then the duration of the execution of the application is monitored as shown at step 84, and then the billable event data is transmitted to the billing server 16, as shown at step 86, after the elapse of the appropriate duration. Otherwise, if the application duration of execution or other parameter of execution is not indicated as a billable event at decision 82, then the process terminates for the monitoring of that particular downloaded application.

FIG. 5 illustrates another embodiment of the process executing on the computer platform of the wireless device 12,18,20,22 wherein billable event data is gathered at the wireless device and then either periodically transmitted from the wireless device to the billing server 16, or transmitted in response to a request from the billing server 16 for transmission of billable event data. The process starts with the wireless device 12,18,20,22 beginning to execute an application, as shown at step 90, and then a determination is made as to whether the application execution is a billable event, as shown at decision 92. If a billable event is indicated at decision 92, then the billable event data is stored at the wireless device 12,18,20,22, as shown at step 94. Then, and also if the application execution is not indicated as a billable event at decision 92, a determination is made as to whether the duration of execution of the application is billed for, as shown at decision 96. If a billable event is indicated at decision 96, then the duration of the execution of the application is monitored as shown at step 98 and the billable event data is stored, as shown at step 100. Then, and also if the application execution is not indicated as a billable event at decision 96, a determination is made as to whether the duration for transmission of billable event data from the wireless device 12,18,20,22 has elapsed, as shown at decision 102.

If the duration has elapsed at decision 102, the billable event data that is stored at the wireless device is transmitted to the billing server 16, as shown at step 106, and then the process terminates. Otherwise, if the duration has not elapsed at decision 102, a determination is then made as to whether the billing server 16 has prompted the wireless device to request transmission of the billable event data, as shown at decision 104. If the billing server 16 has prompted the wireless device, then the wireless device transmits the billing event data to the billing server 16, as shown at step 106, and then the process terminates. If the wireless device has not been prompted to transmit billable event data at decision 104, then the process terminates.

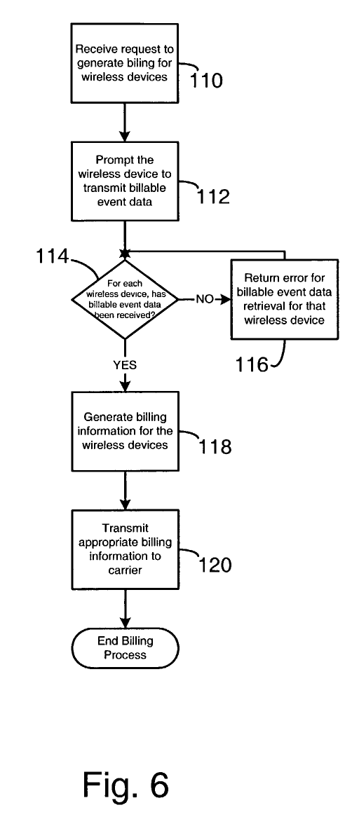

With reference to FIG. 6, one embodiment of the process executing on the billing server 16 is shown in a flowchart illustrating a billing server 16 receiving a request to generate billing for the billable events of the wireless devices 12,18,20,22, as shown at step 110. Then the billing server 16 prompts the wireless devices 12,18,20,22 to transmit their stored billable event data as shown at step 112, and then a determination is made as to whether the billable event data for each wireless device has been received, as shown at decision 114. If the billable event data for a particular wireless device has not been received at decisions 114, an error is returned for the billable event retrieval for that wireless device. Otherwise, once all of the billable events for the wireless devices 12,18,20,22 for which the billing information is requested has been obtained, the billing information is generated, as shown at step 118, and the billing information is then transmitted to the carrier, as shown at step 120, after which the billing information generation process terminates. The embodiment of FIG. 6 assumes that the carrier will ultimately bill the subscriber of the wireless device 12,18,20,22 for all services, but step 120 could likewise be transmitting a bill to the subscriber of the wireless device.

It can be seen that the system 10 thus provides a method for tracking billable events occurring on wireless devices 12,18,20,22 on a wireless network 14 that includes the steps of causing one or more billable events to occur through end-user interaction with a wireless device 12,18,20,22, then creating billable event data based upon the one or more billable events, which can occur either at the billing server 16, and gathering the billable event data with at least the billing server 16 server. The step of gathering the billable event data can occurs only at the at billing server 16, or alternately, can occur at the wireless device 12, and then the method further includes the step of transmitting the billable event data to the at least one server. The method can include the step of generating a bill at the billing server 26 for a wireless device based upon the gathered billable event data. In such embodiment, the method can also include the step of transmitting the bill from the billing server 16 to another computer device, such as stand-alone server 32, on the wireless network 14.

The step of causing one or more billable events can be causing a billable event through the download of an application from an application download server 30 on the wireless network 14 to the wireless device computer platform 50, through the execution of an application on the wireless device, through access of the wireless device to an application resident on another computer device on the wireless network 14, or through the elapse of a duration of execution of an application at the wireless device 12,18,20,22.

The step of transmitting billable event data from the wireless device 12,18,20,22 can be transmitting the billable event data to the billing server 16 at the completion of the event, or at predetermined intervals of time, as shown in FIG. 6. To obtain billable event data from the wireless devices, the method can further the step of prompting the wireless device 12,18,20,22 from the billable server 16 to transmit billable event data, as shown in FIG. 6. Further, the step of creating billable event data can occur at billing server 16, the wireless device 12,18,20,22, or both.

In view of the method being executable on the computer platform of a computer device such as billing server 16 or wireless device 12,18,20,22, the present invention includes a program resident in a computer readable medium, where the program directs a server or other computer device having a computer platform to perform the steps of the method. The computer readable medium can be the memory of the billing server 16, or can be in a connective database, such as billable event database 28. Further, the computer readable medium can be in a secondary storage media that is loadable onto a wireless device computer platform, such as a magnetic disk or tape, optical disk, hard disk, flash memory, or other storage media as is known in the art.

In the context of FIGS. 4, 5 and 6, the method may be implemented, for example, by operating portion(s) of the wireless network 14 to execute a sequence of machine-readable instructions, such as wireless device computer platform 50, the billing server 16, and stand-alone server 32. The instructions can reside in various types of signal-bearing or data storage primary, secondary, or tertiary media. The media may comprise, for example, RAM (not shown) accessible by, or residing within, the components of the wireless network 14. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

What is claimed is:

1. A system for tracking billable events occurring on wireless devices on a wireless network, comprising:
one or more wireless devices selectively in communication with other computer devices across a wireless network, each wireless device including an end-user and computer platform further selectively downloading and executing software applications thereupon and accessible by the end-user, the end-user interaction with the wireless device and with other computer devices across the wireless network causing one or more billable events;
at least one server selectively in communication with the one or more wireless devices across the wireless network; and
wherein billable event data for the one or more wireless devices is gathered at the at least one server.

2. The system of claim 1, wherein the billable event data is gathered only at the at least one server.

3. The system of claim 1, wherein the billable event data is gathered at the wireless device and transmitted to the at least one server.

4. The system of claim 1, wherein the at least one server further generates a bill for a wireless device based upon the gathered billable event data.

5. The system of claim 4, wherein the generated bill is transmitted from the at least one server to another computer device on the wireless network.

6. The system of claim 1, wherein the billable event is the download of an application from an application download server on the wireless network to the wireless device computer platform.

7. The system of claim 1, wherein the billable event is the execution of an application on the wireless device.

8. The system of claim 1, wherein the billable event is access to an application resident on another computer device on the wireless network.

9. The system of claim 1, wherein the billable event is the elapse of a duration of execution of an application.

10. The system of claim 1, wherein the wireless devices transmits billable event data to the at least one server at the completion of the event.

11. The system of claim 1, wherein the wireless devices transmits billable event data to the at least one server upon query from the at least one server.

12. The system of claim 1, wherein the wireless devices transmits billable event data to the at least one server at predetermined intervals of time.

13. A system for tracking billable events occurring on wireless devices on a wireless network, comprising:
a wireless communication means for selectively communicating with computer devices across a wireless network, the wireless communication means causing one or more billable events; and
a means for gathering the billable event data from the wireless communication means.

14. A wireless device selectively in communication with other computer devices across a wireless network, the wireless device including an end-user and computer platform further selectively downloading and executing software applications thereupon and accessible by the end-user, the end-user interaction with the wireless device and with other computer devices across the wireless network causing one or more billable events, and the wireless device gathering billable event data.

15. The wireless device of claim 14, wherein the billable event data is transmitted to another computer device across the wireless network.

16. The wireless device of claim 14, wherein the billable event is the download of an application to the wireless device computer platform.

17. The wireless device of claim 14, wherein the billable event is the execution of an application on the wireless device.

18. The wireless device of claim 14, wherein the billable event is access of the wireless device to an application resident on another computer device on the wireless network.

19. The wireless device of claim 14, wherein the billable event is the elapse of a duration of execution of an application at the wireless device computer platform.

20. The wireless device of claim 15, wherein the wireless devices transmits billable event data to another computer device at the completion of the billable event.

21. The wireless device of claim 15, wherein the wireless device transmits billable event data to another computer device at predetermined intervals of time.

22. A billing server for tracking and invoicing billable events occurring on wireless devices on a wireless network, the server selectively in communication with one or more wireless devices across the wireless network where each wireless device includes an end-user and computer platform further selectively downloading and executing software applications thereupon and accessible by the end-user, the end-user interaction with the wireless device and with other computer devices across the wireless network causing one or more billable events, and the server gathering billable event data from the one or more wireless devices.

23. The server of claim 22, wherein the billable event data is gathered only at the server.

24. The server of claim 22, wherein the billable event data is transmitted from one or more other computer devices on the network to the server.

25. The server of claim 22, wherein the server further generates a bill for a wireless device based upon the gathered billable event data.

26. The server of claim 25, wherein the generated bill is transmitted from the server to another computer device on the wireless network.

27. The server of claim 22, wherein the server prompts the one or more wireless devices to transmit billable event data.

28. The server of claim 24, wherein the server gathers billable event data based upon applications downloaded by wireless devices from other computer devices on the network.

29. A method for tracking billable events occurring on wireless devices on a wireless network, comprising the steps of:
causing one or more billable events to occur through end-user interaction with a wireless device selectively in communication with other computer devices across a wireless network, the wireless device including a computer platform further selectively downloading and executing software applications thereupon and accessible by the end-user;
creating billable event data based upon the one or more billable events; and
gathering the billable event data with at least one server on the wireless network.

30. The method of claim 29, wherein step of gathering the billable event data occurs only at the at least one server.

31. The method of claim 29, wherein the step of gathering billable event data occurs at the wireless device, and further comprising the step of transmitting the billable event data to the at least one server.

32. The method of claim 29, further comprising the step of generating a bill at the at least one server for a wireless device based upon the gathered billable event data.

33. The method of claim 32, further comprising the step of transmitting the bill from the at least one server to another computer device on the wireless network.

34. The method of claim 29, wherein the step of causing one or more billable events is causing a billable event through the download of an application from an application download server on the wireless network to the wireless device computer platform.

35. The method of claim 29, wherein the step of causing one or more billable events is causing a billable event through the execution of an application on the wireless device.

36. The method of claim 29, wherein the step of causing one or more billable events is causing a billable event through access of the wireless device to an application resident on another computer device on the wireless network.

37. The method of claim 29, wherein the step of causing one or more billable events is causing a billable event through the elapse of a duration of execution of an application at the wireless device.

38. The method of claim 31, wherein the step of transmitting billable event data from the wireless device is transmitting the billable event data to the at least one server at the completion of the event.

39. The method of claim 31, further comprising the step of prompting the wireless device from the at least one server to transmit billable event data.

40. The method of claim 31, wherein the step of transmitting billable event data from the wireless device is transmitting the billable event data to the at least one server at predetermined intervals of time.

41. The method of claim 34, wherein the step of creating billable event data occurs at the at least one server.

42. The method of claim 29, wherein the step of creating billable event data occurs at the wireless device.

43. A method for tracking billable events occurring on wireless devices on a wireless network, comprising the steps of:
a billable event causation step at a wireless device on a wireless network;
a data creation step of billable event data based upon the one or more billable events; and
a data gathering step of the billable event data that occurs at an at least one server on the wireless network.

44. A computer program that, when executed by a computer device on a wireless network, records billable events occurring on wireless communication devices on a wireless network through performing the steps of:
gathering data from one or more wireless communication devices for billable events that occur through end-user interaction with the wireless communication device, the wireless communication device selectively in communication with other computer devices across the wireless network and selectively downloading and executing software applications thereupon; and
creating billing data for the one or more wireless communication devices based upon the one or more billable events that occur at the respective wireless devices.

45. The program of claim 44, wherein the program causes the step of gathering the billable event data to occur only at the computer device.

46. The program of claim 44, wherein the program causes the step of gathering billable event data to occur at the wireless communication device, and further comprising the step of transmitting the billable event data to the at least one server.

47. The program of claim 44, wherein the program further directs the computer device to perform the step of generating a bill for a wireless communication device based upon the gathered billable event data.

48. The program of claim 44, wherein the program further directs the computer device to perform the step of transmitting the bill to another computer device on the wireless network.

49. The program of claim 44, wherein the program further directs the computer device to perform the step of prompting a wireless communication device to transmit billable event data.
